(19) United States
(12) Patent Application Publication
(10) Pub. No.: US 2015/0310356 A1
(43) Pub. Date: Oct. 29, 2015

(54) FACILITY AND INFRASTRUCTURE UTILIZATION

(71) Applicant: IMS SOLUTIONS, INC., Schaumburg, IL (US)

(72) Inventors: Otman A. Basir, Waterloo (CA); William Ben Miners, Guelph (CA)

(21) Appl. No.: 14/657,526

(22) Filed: Mar. 13, 2015

Related U.S. Application Data
(60) Provisional application No. 61/952,235, filed on Mar. 13, 2014.

(51) Int. Cl. G06Q 10/06; G07C 5/00

(52) U.S. Cl. CPC G06Q 10/063; G07C 5/008

(57) ABSTRACT

A facility utilization system includes a plurality of vehicles with telematics systems. A server receives telematics information from the plurality of vehicles, including location information of each of the plurality of vehicles. The server compares the location information to a location of at least one facility to determine facility utilization. The server monitors utilization of the at least one facility based upon the comparison of the location information of the plurality of vehicles to the location of the at least one facility.

### BACKGROUND

Typical transportation analysis focuses on the efficient movement of goods and services throughout the transportation network. This transportation analysis may include fuel utilization, an analysis of vehicle and driving behavior, or route optimization. While transportation analysis is maturing, solutions are not readily available to analyze facilities surrounding or supporting the transportation network.

### SUMMARY

This invention focuses on facility utilization, leveraging available information from infrastructure, from vehicle movements, and from other sources of information to determine usage characteristics of one or more facilities. Understanding the utilization of facilities is important to optimize the placement of parking facilities, to assess an appropriate value for parking, to understand the utilization of specific road segments or intersections, and other key facilities. A facility-based approach is important to fully understand the impact of transportation not just on the vehicle and the road network, but also key interactions between facilities and vehicles.

One example of a facility utilization system includes a plurality of vehicles with telematics systems. A server receives telematics information from the plurality of vehicles, including location information of each of the plurality of vehicles. The server compares the location information to a location of at least one facility to determine facility utilization. The server monitors utilization of the at least one facility based upon the comparison of the location information of the plurality of vehicles to the location of the at least one facility.

### BRIEF DESCRIPTION OF THE DRAWINGS

FIG. 1 is a schematic of one embodiment of the present invention.

### DETAILED DESCRIPTION OF A PREFERRED EMBODIMENT

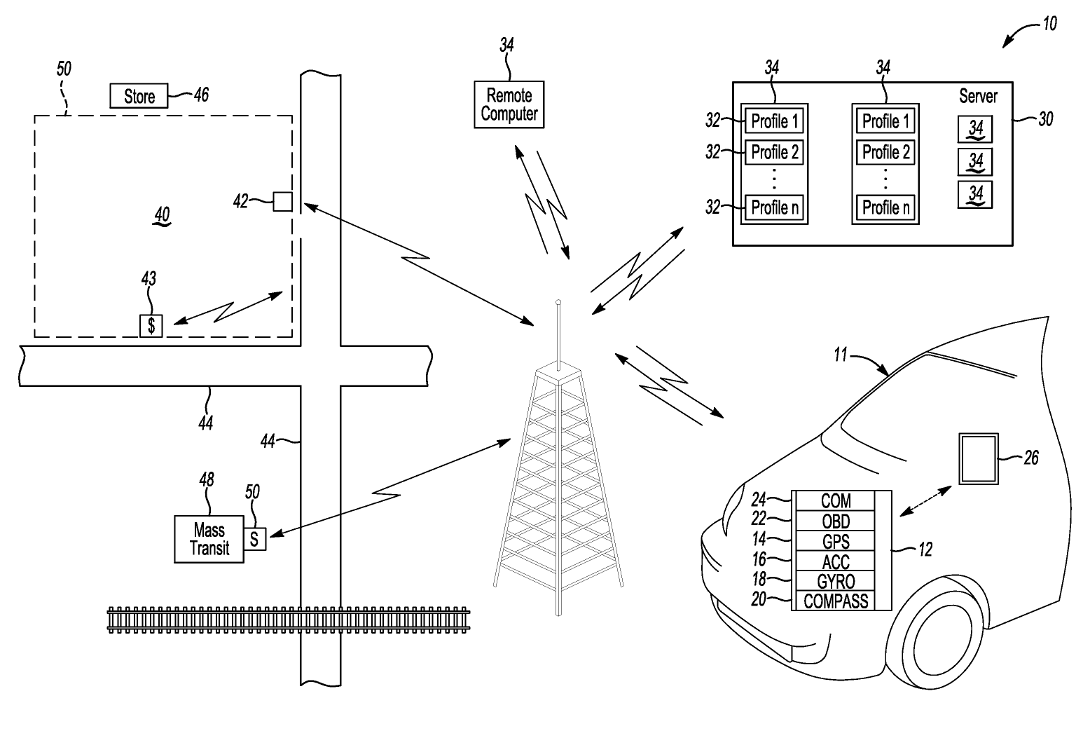

FIG. 1 is a schematic of a facility and infrastructure utilization monitoring system 10 according to one embodiment of the present invention. A motor vehicle 11 includes a plurality of data gathering devices that communicate information to a telematics appliance 12 installed within the vehicle 11. The example data gathering devices include a global positioning satellite (GPS) receiver 14, a three-axis accelerometer 16, a gyroscope 18 and an electronic compass 20, which could be housed within the appliance 12 (along with a processor and suitable electronic storage, etc. and suitably programmed to perform the functions described herein). As appreciated, other data monitoring systems could be utilized within the contemplation of this invention. Data may also be collected from an onboard diagnostic port (OBD) 22 that provides data indicative of vehicle engine operating parameters such as vehicle speed, engine speed, temperature, fuel consumption (or electricity consumption), engine idle time, car diagnostics (from OBD) and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples. The GPS receiver 14 may be sufficient by itself.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication.

The in vehicle appliance 12 gathers data from the various sensors mounted within the vehicle 11 and stores that data. The in vehicle appliance 12 transmits this data (or summaries or analyses thereof) as a transmission signal through a wireless network to a server 30 (also having at least one processor and suitable electronic storage and suitably programmed to perform the functions described herein). The server 30 utilizes the received data to categorize vehicle operating conditions in order to determine or track vehicle use. This data can be utilized for tracking and determining driver behavior, insurance premiums for the motor vehicle, tracking data utilized to determine proper operation of the vehicle and other information that may provide value such as alerting a maintenance depot or service center when a specific vehicle is in need of such maintenance. Driving events and driver behavior are recorded by the server 30, such as fuel and/or electricity consumption, speed, driver behavior (acceleration, speed, etc.), distance driven and/or time spent in certain insurance-risk coded geographic areas. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 11 (or alternatively, with a user). Among other things, the profiles 32 each contain information about the vehicle 11 (or user) including some or all of the gathered data (or summaries thereof). Some or all of the data (or summaries thereof) may be accessible to the user via a computer 34 over a wide area network (such as the internet) via a policyholder portal, such as fuel efficiency, environmental issues, location, maintenance, etc. The user can also customize some aspects of the profile 32.

It should be noted that the server 30 may be numerous physical and/or virtual servers at multiple locations. The server 30 may collect data from appliances 12 from many different vehicles 11 associated with a many different insurance companies. Each insurance company (or other administrator) may configure parameters only for their own users. The server 30 permits the administrator of each insurance company to access only data for their policyholders. The server 30 permits each policyholder to access only his own profile and receive information based upon only his own profile.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

The present invention described below can be implemented with the system 10 described above or variations thereof. The present invention can be implemented with existing telematics systems, particularly fleet telematics systems, with the additional functions described below.

The system 10 analyzes facility and infrastructure utilization, such as a parking lot 40 for vehicles such as vehicle 11. Ideally, all vehicles in a fleet or all (or nearly all) vehicles in a geographic area would be equipped like vehicle 11. Alternatively, analysis can be performed based upon a sampling of vehicles if only a percentage of vehicles in the area are equipped with telematics like vehicle 11. This information can be augmented by other sensors, such as an entry control system 42 (e.g. gate) at the parking lot 40. The entry control system 42 is equipped with sensors and communication capability to be able to monitor vehicles entering and leaving the parking lot 40 and send this information to the server 30. The parking lot 40 may also have a parking payment system 43 which is in communication with the server 30. The parking payment system 43 may be of the type where a user pays for a particular spot in the parking lot 40 by credit card or electronic account payment. The parking lot 40 may also have cameras or other sensors for monitoring the level of occupancy. The parking lot 40 is adjacent roads 44 and accessible from at least one of the roads 44.

At least one destination 46, such as a store, gym, etc is proximate the parking lot 40. The parking lot 40 is close enough to the at least one destination that there is a high likelihood that vehicles 11 parked in the parking lot 40 belong to people who are visiting the destinations.

The parking lot 40 may also be proximate a mass transit station 48, such as a bus stop or train station. The transit station 48 is associated with a server 50 (which may or may not be located on-site) that contains the schedule for arriving and departing mass transit carriers, such as busses, trains, etc. The schedule is sent to the server 30. Alternatively, or additionally, actual information indicating actual arrival and departure times of the mass transit carriers could be sent to the server 30.

By monitoring the telematics information from the vehicles 11, the system 10 collects, analyzes, and reports on utilization information for one or more facilities such as the parking lot 40. The facility may be the parking lot 40 but may also be a roadside parking spot, a house, shopping center, gas station, drive-through, or a building. The parking lot 40, or other facility, may be defined by a geo-fence 50, so when a vehicle 11 is located within the geo-fence 50, the vehicle 11 is considered to be in the parking lot 40. The location of the vehicle 11 may be sent from the appliance 12 to the server 30, where the server 30 compares the vehicle 11 location to the geo-fence 50. Alternatively, the geo-fence 50 may be stored locally on the appliance 12 and the location of the vehicle 11 is only sent to the server 30 when the appliance determines its presence in the parking lot 40.

The system 10 may further derive usage statistics describing usage of defined parking locations, including but not limited to, turnover rates and parking duration. Factors included in the statistical model may include time of day, day of week, weather conditions, road network changes (road closures, detours), and special events in close proximity to the facility.

Usage statistics may be derived based on monitoring vehicle 11 movements, integrating information from parking reservation systems, integrating information from parking payment systems 43, and/or integrating information from infrastructure occupancy sensors.

Usage statistics may describe facility utilization based on the origin of vehicles 11. The origin may be approximated using a general direction, such as “from the east,” “from the west,” “from the south,” or “from the north,” or with local geography references “from downtown,” or “from the east-end.” The origin may be automatically classified as a home, work, or other contextually relevant location class.

The facility utilization statistics may be based on the demographic, sociographic, and/or psychographic characteristics of the occupant(s) in each vehicle. By analyzing origin-destination patterns, telematics from the appliance 12 in the vehicle 11, and/or parking reservation systems (most require registration with additional details), the server 30 can infer some demographic and psychographic information. Psychographic information includes interests (i.e. does the vehicle frequent a bulk-food store?) and lifestyle (i.e. does this vehicle regularly visit a gym facility?). Inferring this information about vehicles 11 in a parking lot is valuable for shopping centers/retail and urban planning activities around the parking lot 40 itself.

The system 10 may also correlate facility utilization with alternate modes of transportation, including linking the parking lot 40 with the nearby transit station 48. By linking into bus or train arrival and departure times from server 50, and their proximity to the parking lot 40, and comparing the arrival and/or departure times of the vehicles 11 with the departure/arrival times of the mass transit, hypotheses can be formed about the intended use of the parking lot 40. For example, vehicles 11 arriving shortly before train or bus departure, then leaving shortly after train or bus returns are likely used for commuting. If a parking lot 40 is used primarily to host vehicles 11 while the occupants are traveling on the bus or train, it can be valuable to offer combined parking & train fares, or to revisit the purpose of the parking lot 40 to optimize value, incentives, or revenues generated by the parking lot 40.

The facility may be a portion of the road network or real-estate, including but not limited to an intersection of roads 44, a defined geographic boundary, or a road 44 segment of interest.

The facility may be a bus, train, subway, taxi, or other means of transport in which utilization is measured in part based on occupancy. Occupancy in mass transit can be performed by cameras or other sensors.

The system 10 may assess a static or dynamic usage-based charge (e.g. through the user profile 34, such as a credit card stored in the profile 34) for use of the facility based on one or more factors including duration, arrival time, departure time, day of week, special events, vehicle type, vehicle mass, facility congestion/availability, and/or linkage with alternate modes of transportation (bus, train, subway, carpool, etc.). Vehicle 11 type and mass is determined from the VIN. The VIN is read by the appliance 12. Duration, arrival time, departure time, day of week relies on an accurate clock reference. Special events are updated manually—typically relevant for modern parking reservation systems. Linkage with mass transit 48 can be determined if the driver used a parking reservation system (or inferred based on correlation of bus/train arrival/departure and vehicle activity, as explained above). All of this information can be used to calculate a fair and individualized charge for each vehicle using the facility.

The server 30 may predict facility usage based on historical statistics and observed context, including upcoming special events, road network changes (closures, detours), weather conditions, time of day, day of week, and/or season.

The system 10 may provide personalized notification to travelers during journey planning, while in transit searching for a facility of interest, or directly to travelers in close proximity to the facility using traditional infrastructure notification or remote communication methods to reach the traveler. The system 10 may also analyze asset utilization including facility based information about the presence, absence, and asset location within the facility.

The system 10 may generate transaction reports identifying the movement of vehicles 11 in and out of each facility (i.e. each transaction includes: parking lot, vehicle, date/time, in/out). The system 10 may generate parking reports describing parking behavior of each vehicle 11 (i.e. each entry includes: parking lot, vehicle, date/time arrival in lot, parking duration, departure from lot). The system 10 may generate departure reports describing the absence of each vehicle 11 from the facility (i.e. each entry includes: parking lot, vehicle, date/time departure from lot, time away from lot, arrival in lot). The system 10 may also generate parking lot usage reports summarizing each vehicle 11 in each facility (i.e. each entry includes: parking lot, vehicle, total time in lot, total time away from lot, last parking time, last departure time).

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A facility utilization system comprising:
a server receiving telematics information from a plurality of vehicles, the telematics information including location information of each of the plurality of vehicles, the server comparing the location information to a location of at least one facility, the server monitoring utilization of the at least one facility based upon the comparison of the location information of the plurality of vehicles to the location of the at least one facility.

2. The system of claim 1 further including a plurality of telematics systems, each in one of the plurality of vehicles, each of the plurality of telematics systems including a communication module.

3. The system of claim 2 wherein each of the plurality of telematics system 10s includes a gps receiver.

4. The system of claim 1 wherein the facility is a parking facility.

5. The system of claim 4 wherein the server derives usage statistics for the parking facility.

6. The system of claim 4 wherein the server receives information from the parking facility regarding occupancy of the parking facility.

7. The system of claim 1 wherein the server determines durations that the vehicles are located at the facility.

8. The system of claim 1 wherein the server compares the locations of the vehicles to a geo-fence associated with the facility.

9. The system of claim 1 wherein the server monitors direction of travel of the vehicles to the facility.

10. The system of claim 1 wherein the server compares arrival times of the vehicles to the facility to departure times of nearby mass transit.

11. The system of claim 10 wherein the server compares departure times of the vehicles from the facility to arrival times of nearby mass transit.

12. The system of claim 1 wherein the server assigns a charge to accounts associated with the vehicles based upon the utilization of the facility by the vehicles.

13. A method for monitoring facility utilization including the steps of:
receiving telematics information from a plurality of vehicles, the telematics information including location information of each of the plurality of vehicles;
comparing the location information to a location of at least one facility; and
monitoring utilization of the at least one facility based upon the comparison of the location information of the plurality of vehicles to the location of the at least one facility.

14. The method of claim 13 wherein the location information includes gps location information.

15. The method of claim 13 wherein the facility is a parking facility.

16. The method of claim 14 further including the step of deriving usage statistics for the parking facility.

17. The method of claim 16 further including the step of receiving information from the parking facility regarding occupancy of the parking facility.

18. The method of claim 13 further including the step of determining durations that the vehicles are located at the facility.

19. The method of claim 13 further including the step of comparing the locations of the vehicles to a geo-fence associated with the facility.

20. The method of claim 13 further including the step of monitoring direction of travel of the vehicles to the facility.

21. The method of claim 13 further including the steps of:
comparing arrival times of the vehicles to the facility to departure times of nearby mass transit; and
comparing departure times of the vehicles from the facility to arrival times of nearby mass transit.

22. The method of claim 13 further including the step of assigning a fee charge to accounts associated with the vehicles based upon the utilization of the facility by the vehicles.
